(19) United States
(12) Patent Application Publication
(10) Pub. No.: US 2014/0130170 A1
(43) Pub. Date: May 8, 2014

(54) INFORMATION SECURITY AUDIT METHOD, SYSTEM AND COMPUTER READABLE STORAGE MEDIUM FOR STORING THEREOF

(71) Applicant: INSTITUTE FOR INFORMATION INDUSTRY, Taipei (TW)

(72) Inventors: Chien-Ting KUO, Taichung City (TW); He-Ming RUAN, Kaohsiung City (TW); Chin-Laung LEI, Taipei City (TW)

(73) Assignee: INSTITUTE FOR INFORMATION INDUSTRY, Taipei (TW)

(21) Appl. No.: 13/686,897

(22) Filed: Nov. 27, 2012

(30) Foreign Application Priority Data
Nov. 6, 2012 (TW) 101141166

(51) Int. Cl. G06F 21/57

(52) U.S. Cl. CPC G06F 21/577
USPC 726/25

(57) ABSTRACT

An information security audit method used in an information security audit system is provided. The information security audit method comprises the steps outlined below. A normalized weighting of each of a plurality of members of an organization is computed according to a level and at least one feature of each of the members. A plurality of risk evaluation values corresponding to a plurality of audit items are computed and a normalized risk evaluation value of each of the members is further computed according to the risk evaluation values and the normalized weighting. A relation of the normalized risk evaluation value and a plurality of threshold value intervals are determined to dynamically adjust an audit period and/or a number of the audit items according to the relation.

### RELATED APPLICATIONS

This application claims priority to Taiwan Application Serial Number 101141166, filed Nov. 6, 2012, which is herein incorporated by reference.

### BACKGROUND

1. Technical Field

The present invention relates to an information security technology. More particularly, the present invention relates to an information security audit method, system and computer readable storage medium for storing thereof.

2. Description of Related Art

By using the highly developed technologies of network and computer, large amount of information can be processed and stored in the computer device and can be transmitted through the network. With the aid of the computer and the network, the information can be processed and managed rapidly. However, the hacker may attack the vulnerability of the computer and network system such that the confidential information of an organization, whether it is a company or a government institution, is leaked. Hence, the information security is an important issue.

In the conventional management flow of the information security, the risk evaluation is only performed on a single vulnerability or an important asset. The risk evaluation covering the whole organization or the whole corporation cannot be made. Further, the risk evaluation is often performed manually with fixed period, which is inefficient. The possibility of the occurrence of the information security events becomes high due to the inefficient risk evaluation.

Accordingly, what is needed is an information security audit method, system and computer readable storage medium for storing thereof to address the above issues.

### SUMMARY

An aspect of the present invention is to provide an information security audit system. The information security audit system comprises a group differentiation module, a risk evaluation module and a dynamic audit module. The group differentiation module computes a normalized weighting of each of a plurality of members of an organization according to a level and at least one feature of each of the members. The risk evaluation module computes a plurality of risk evaluation values corresponding to a plurality of audit items of the members and further computes a normalized risk evaluation value of each of the members according to the risk evaluation values and the normalized weighting. The dynamic audit module determines a relation between the normalized risk evaluation value and a plurality of threshold value intervals and/or between the risk evaluation values and the plurality of threshold value intervals to dynamically adjust an audit period and/or a number of the audit items according to the relation.

Another aspect of the present invention is to provide an information security audit method used in an information security audit system, wherein the information security audit method comprises the steps outlined below. A normalized weighting of each of a plurality of members of an organization is computed according to a level and at least one feature of each of the members. A plurality of risk evaluation values corresponding to a plurality of audit items of the members and a normalized risk evaluation value of each of the members are computed according to the risk evaluation values and the normalized weighting. A relation between the normalized risk evaluation value and a plurality of threshold value intervals and/or between the risk evaluation values and the plurality of threshold value intervals to dynamically adjust an audit period and/or a number of the audit items is determined according to the relation.

Yet another aspect of the present invention is to provide a computer readable storage medium to store a computer program to execute an information security audit method used in an information security audit system, wherein the information security audit method comprises the steps outlined below. A normalized weighting of each of a plurality of members of an organization is computed according to a level and at least one feature of each of the members. A plurality of risk evaluation values corresponding to a plurality of audit items of the members and a normalized risk evaluation value of each of the members are computed according to the risk evaluation values and the normalized weighting. A relation between the normalized risk evaluation value and a plurality of threshold value intervals and/or between the risk evaluation values and the plurality of threshold value intervals to dynamically adjust an audit period and/or a number of the audit items is determined according to the relation.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a block diagram of an information security audit system in an embodiment of the present invention;

FIG. 2 is a diagram of a structure of the organization in an embodiment of the present invention;

FIG. 3 is a diagram of an intuitive display interface of the risk evaluation in an embodiment of the present invention;

FIG. 4 is a flow chart of a information security audit method in an embodiment of the present invention;

FIG. 5 is a detailed flow chart for dynamically adjusting the audit period in an embodiment of the present invention; and

FIG. 6 is a detailed flow chart for dynamically adjusting the number of he audit items in an embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

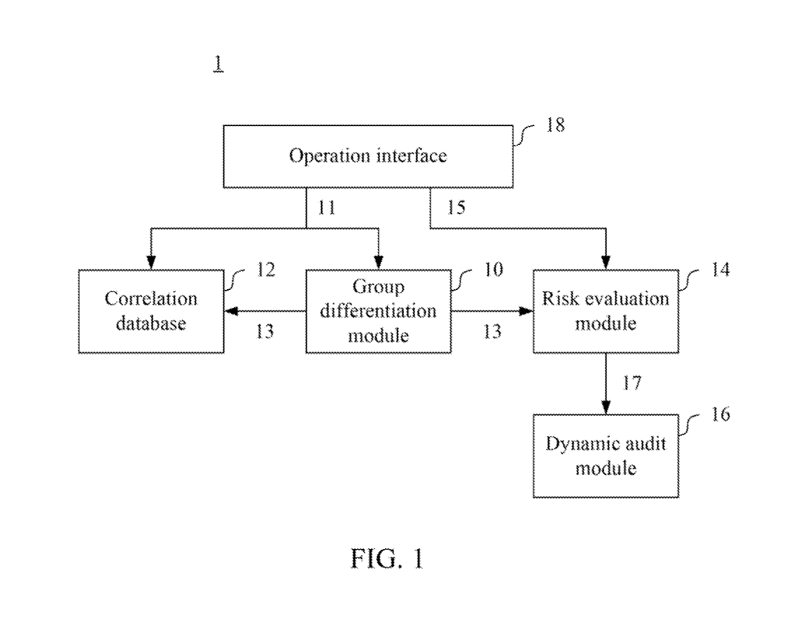

FIG. 1 is a block diagram of an information security audit system 1 in an embodiment of the present invention. The information security audit system 1 comprises a group differentiation module 10, a correlation database 12, a risk evaluation module 14, a dynamic audit module 16 and an operation interface 18.

The operation interface 18 provides an interface for a user to input organization information 11 of an organization. The organization information 11 may comprise the level of each of the members in the organization and at least one feature of each of the members. It is noted that the tern “organization” can be, but not limited to, a company, a club or an institution. The members can be categorized into different levels from high-level members (e.g. a division or a department) to low-level members (e.g. a team or a staff). Further, the members can include human members (e.g. staffs) or non-human members (e.g. system resources such as, but not limited, to a personal computer, a development system or a network management system).

In the present embodiment, the feature may comprise, but not limited to a member attribute, a member asset a member performance or a combination of the above. For example, the member attribute can be a level of confidentiality of the members (e.g. high, medium and low confidential levels). The member asset can be the value of the system resource owned by each of the teams in the organization. The member performance can be a value of revenue of each of the divisions in the organization. It is noted that the above description is merely an example. In other embodiments, different kinds of attribute, asset and performance can be assigned to each of the members.

The group differentiation module 10 computes a normalized weighting 13 of each of the members in the organization according to the organization information 11, in which the organization information 11 may comprise the level and the feature of each of the members. In an embodiment, the group differentiation module 10 can compute the normalized weighting 13 by using, but not limited to, a prorating method according to the level and the feature of each of the members. A more detailed example will be shown in subsequent paragraphs. In the present embodiment, the organization information 11 and the corresponding normalized weighting 13 are stored in the correlation database 12.

The operation interface 18 further allows the user to input a plurality of audit items 15 corresponding to each of the members. The audit items 15 can be used to, but not limited to, detect the version and the updating date of the anti-virus software, the password strength in the system resource (e.g. the personal computer, the development system or the network management system), the setting of the firewall, the setting of the intrusion detection system and the system resource vulnerability scanning items. The risk evaluation module 14 computes a plurality of risk evaluation values corresponding to the audit items 15 of each of the members. For example, each of the risk evaluation values can be a value ranging from, but not limited to, 0 to 100, in which a higher risk evaluation value stands for a higher risk. Various conventional methods can be used to compute the risk evaluation values of different audit items 15. Hence, no further detail is discussed herein. The risk evaluation module 14 further computes a normalized risk evaluation value of each of the members according to the risk evaluation values and the normalized weighting 13.

In an embodiment, the risk evaluation module 14 performs computation of the normalized risk evaluation value from the normalized risk evaluation value of a lowest-level member to the normalized risk evaluation value of a highest-level member in sequence.

The dynamic audit module 16 determines a relation between the risk values 17 and a plurality of threshold value intervals to dynamically adjust an audit period and/or a number of the audit items 15 according to the relation, in which the risk value 17 comprises the normalized risk evaluation value and/or the risk evaluation values. In other words, the dynamic audit module 16 determines a relation between the normalized risk evaluation value and the threshold value intervals and/or between the risk evaluation values and the threshold value intervals to dynamically adjust an audit period and/or a number of the audit items.

The audit period is the interval of time between two audit processes. The decreasing of the audit period shortens the audit period. On the contrary, the increasing of the audit period lengthens the audit period. For example, the audit period is decreased if the frequency of performance of the audit processes changes from once every two weeks to once a week, and the audit period is increased if the frequency of performance of the audit processes changes from once a week to once every two weeks.

The number of the audit items 15 can be adjusted by either increasing or decreasing them. For example, the audit items can be increased from two items including the detection of the brand and the version of the anti-virus software of the system resource to four items including the detection of the brand, the version, the updating date and the scanning frequency of the anti-virus software of the system resource. On the other hand, the number of the audit items 15 can be decreased from four items including the detection of the setting of the firewall system policy or the intrusion detection system, the password strength, the vulnerability scanning items and the user authority to one item including the password strength only.

In an embodiment, when the normalized risk evaluation value and/or the risk evaluation values vary from a first threshold value interval to a second threshold value interval, wherein any first values in the first threshold value interval is lower than any second values in the second threshold value interval, the dynamic audit module 16 decreases the audit period and/or increases the number of the audit items. For example, when the normalized risk evaluation value of a member varies from the value interval of 51˜60 to the value interval of 61˜70 the dynamic audit module 16 determines that the risk becomes higher and dynamically decreases the audit period and/or increases the number of the audit items

In another embodiment, when the normalized risk evaluation value and/or the risk evaluation values vary from a first threshold value interval to a second threshold value interval, wherein any first values in the first threshold value interval is larger than any second values in the second threshold value interval, the dynamic audit module 16 increases the audit period and/or decreases the number of the audit items. For example, when the normalized risk evaluation value of a member varies from the value interval of 91˜100 to the value interval of 71˜80 the dynamic audit module 16 determines that the risk becomes lower and dynamically decreases the audit period and/or increases the number of the audit items.

In different embodiments, the dynamic audit module 16 adjusts the audit period and/or the number of the audit items according to a specific ratio or an audit item correlation. For example, when the normalized risk evaluation value varies from the value interval of 51˜60 to the value interval of 61˜70, the dynamic audit module 16 decreases the audit period to half of the period corresponding to the interval 51˜60. When the normalized risk evaluation value varies from the value interval of 61˜76 to the value interval of 71˜80, the dynamic audit module 16 further decreases the audit period to ¼ of the period corresponding to the interval 61˜70.

A similar strategy can be used on the adjustment of the number of the audit items. For example, when the normalized risk evaluation value varies from the value interval of 51˜60 to the value interval of 61˜70, the dynamic audit module 16 increases the number of the auditing items from 3 items to 6 items. When the normalized risk evaluation value varies from the value interval of 61˜70 to the value interval of 71˜80, the dynamic audit module 16 increases the number of the auditing items from 6 items to 8 items according to a default ratio and can further add two more auditing items that are related to the 8 auditing items additionally such that the total number of the auditing items becomes 10. (For example, if the original auditing items are related to the antivirus software that is for preventing the computer system from intrusion of the virus, the auditing items that are related to the firewall settings can be added) It is noted that the ratio described above is merely an example. In other embodiments, other ratio settings can be used to adjust the audit period and/or the number of the audit items.

In an embodiment, the dynamic audit module 16 can further adjust a frequency of a warning message delivering process and/or an event-handling process according to the relation. For example, when the normalized risk evaluation value varies from a lower value interval to a higher value interval, the frequency of the warning message delivering process and/or the event-handling process can be increased to notify the related members to manage the vulnerability instantly or update the database more frequently. For example, the event-handling process can be performed by the adjustment of the software/hardware or be performed by holding staff-training programs. The warning message delivering process can be performed by sending warning e-mail to the members in the organization.

Hence, since the adjustment of the audit period and the number of the audit items is based on the normalized risk evaluation value of each of the members that is computed according to their level and the feature, the adjustment can be performed dynamically. The level of the security of the organization can be monitored and adjusted in a dynamic way.

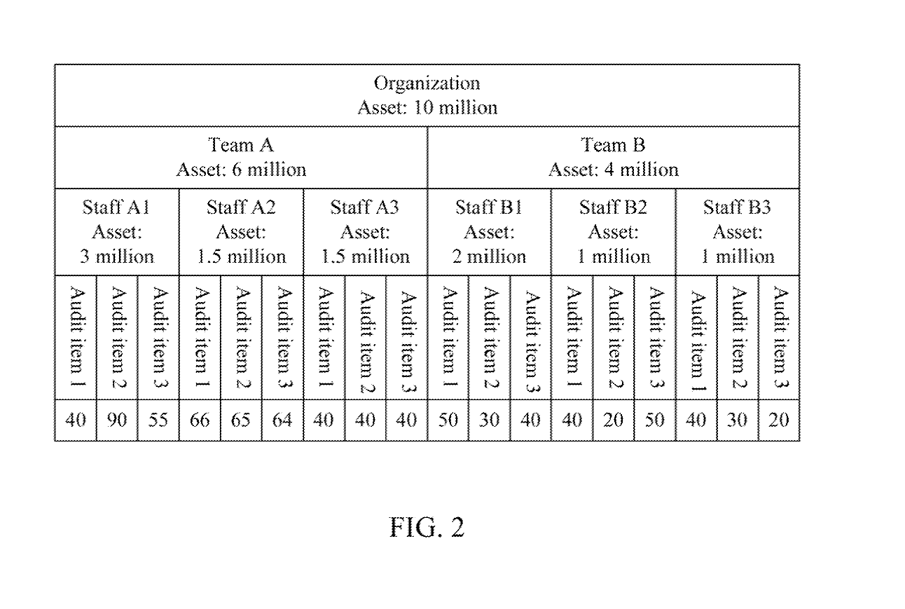

FIG. 2 is a diagram of a structure of an organization in an embodiment of the present invention. In this embodiment, the total asset of the organization is 10 million. The organization can be categorized into two teams A and B, in which the asset of team A is 6 million and the asset of team B is 4 million. Team A further includes three staffs A1, A2 and A3 having the assets of 3 million, 1.5million and 1.5 million respectively. Team B also includes three staffs B1, B2 and B3 having the assets of 2 million, 1 million and 1 million respectively. Each of the staffs There are three audit items corresponding to, in which the risk evaluation values of the three audit items are listed.

If the normalized weighting of the organization is 1, the group differentiation module 10 can determine the normalized weightings of team A and team B that are in the same level as 0.6 and 0.4 respectively according to their assets. Based on the similar strategy, the normalized weightings of staffs A1, A2 and A3 are determined to be 0.5, 0.25 and 0.25 respectively. The normalized weightings of staffs B1, B2 and B3 are determined to be 0.5, 0.25 and 0.25 respectively.

Since the risk evaluation values of the three audit items of staff A1 are 40, 90 and 55, the risk evaluation module 14 can compute the normalized risk evaluation value by averaging them in the present embodiment. Hence, the normalized risk evaluation value of staff Al is (40+90+55)/3=61.67. Similarly, the normalized risk evaluation values of staff A2 and A3 can be computed by the risk evaluation module 14 as 65 and 40 respectively, and the normalized risk evaluation values of staff B1, B2 and B3 can be computed by the risk evaluation module 14 as 40, 36.67 and 30 respectively.

The risk evaluation module 14 can further compute the normalized risk evaluation values of team A and team B by taking the normalized weightings of staffs A1, A2, A3, 61, B2 and B3 into account. Accordingly, the normalized risk evaluation value of team A is 61.67*0.5+65*0.25+40*0.25=57.085 and the normalized risk evaluation value of team B is 40*0.5 36.67*0.25+30*0.25=36 66. Further, by taking the normalized weightings of team A and B into account, the normalized risk evaluation value of the organization is determined by the risk evaluation module 14 as 48.315.

The dynamic audit module 16 determines the relation between the normalized risk evaluation value and a plurality of threshold value intervals and/or between the risk evaluation values and the threshold value intervals. For example, if the risk evaluation value of the audit item 2 of staff A1 is over the threshold value of 70, the dynamic audit module 16 adjusts the audit period from once every two weeks to once a week. If the normalized risk evaluation values of both of the staffs A1 and A2 is larger than the threshold value 65, the audit period of all the audit items corresponding to staffs A1 and A2 is adjusted from once every two weeks to once a week, while in another embodiment, the audit period of all the audit items corresponding to all the members in team A can all be adjusted from once every two weeks to once a week. Since the risk evaluation value of the audit item 2 of staff A1 varies from the interval of 71˜80 to the interval of 81˜90, the dynamic audit module 16 can also determine to increase the number of audit items of staff A1 to 5 items.

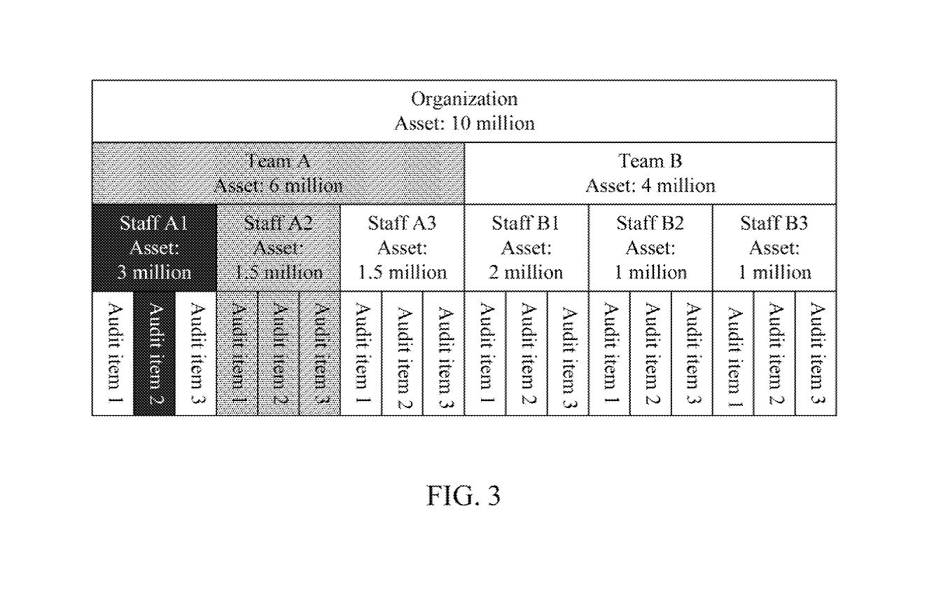

FIG. 3 is a diagram of an intuitive display interface of the risk evaluation in an embodiment of the present invention. In the present embodiment, the risk evaluation module 14 can further display the computed risk evaluation values and the normalized risk evaluation values in the display interface shown in FIG. 3 on a system display module (not shown). The groups, sub-groups of the organization and the total risk evaluation values can be shown on the interface in an intuitive way by using different colors. In other embodiments, other output devices can be used to display the security condition of the organization by using intuitive methods such as, but not limited to, the size of the graph, the volume of the audio output and the frequency range of the audio output.

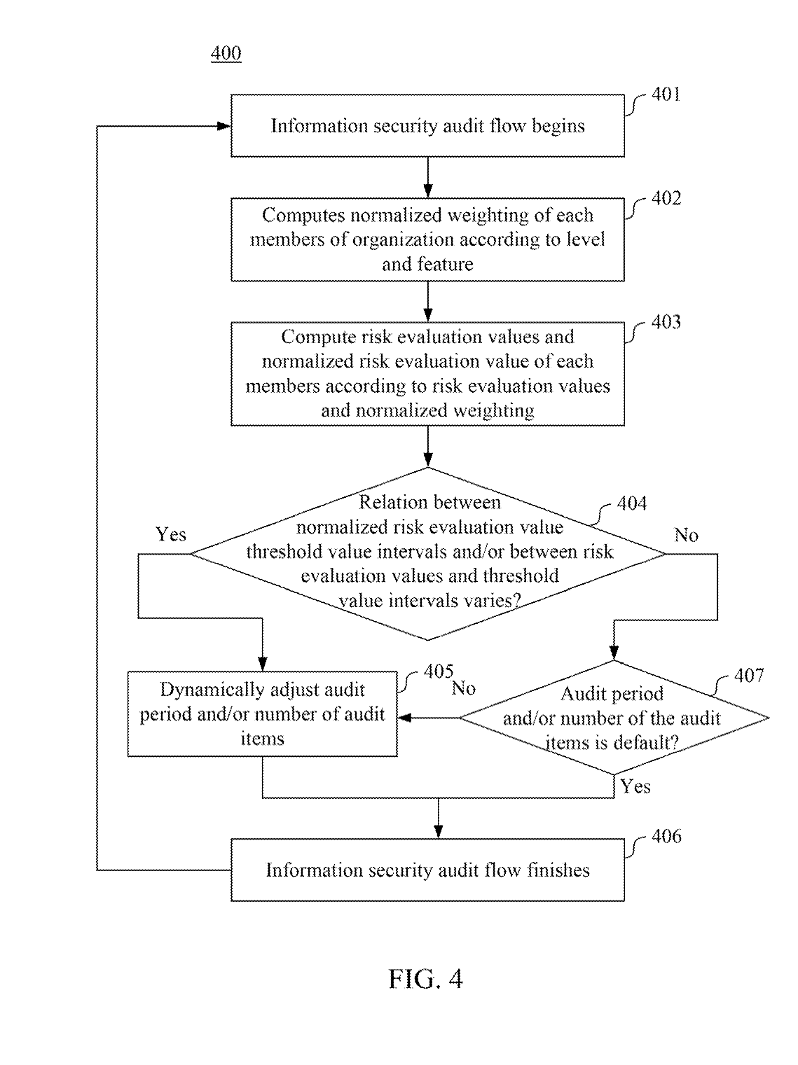

FIG. 4 is a flow chart of an information security audit method 400 in an embodiment of the present invention. The information security audit method 400 can be used in the information security audit system 1 depicted in FIG. 1. The computer program can be stored in a computer readable medium such as a ROM (read-only memory), a flash memory, a floppy disc, a hard disc, an optical disc, a flash disc, a tape, an database accessible from a network, or any storage medium with the same functionality that can be contemplated by persons of ordinary skill in the art to which this invention pertains.

In step 401, the information security audit flow begins.

In step 402, the group differentiation module 10 computes a normalized weighting of each of a plurality of members of an organization according to a level and at least one feature of each of the members.

In step 403, the risk evaluation module 14 computes a plurality of risk evaluation values corresponding to a plurality of audit items of the members and further computing a normalized risk evaluation value of each of the members according to the risk evaluation values and the normalized weighting.

In step 404, the dynamic audit module 16 determines whether a relation between the normalized risk evaluation and a plurality of threshold value intervals value and/or between the risk evaluation values and the threshold value intervals varies.

When the relation varies, i.e. the normalized risk evaluation value or the risk evaluation value varies from one threshold value intervals to another threshold value intervals, the dynamic audit module 16 dynamically adjust an audit period and/or a number of the audit items in step 405. The flow continues to step 406 after step 405 to finish the information security audit flow. The audit process of the organization is performed based on the adjusted audit period and the number of the audit items until the next information security audit flow begins.

When the relation does not vary, whether the audit period and/or the number of the audit items is a default value is determined in step 407, in which the audit period and/or the number of the audit items corresponds to the threshold value intervals that the normalized risk evaluation value and/or the risk evaluation value currently locate. When the audit period and/or the number of the audit items is not the default value, the flow continues to step 405 to adjust the audit period and/or the number of the audit items. When the audit period and/or the number of the audit items is the default value, the flow continues to step 406 to finish the information security audit flow.

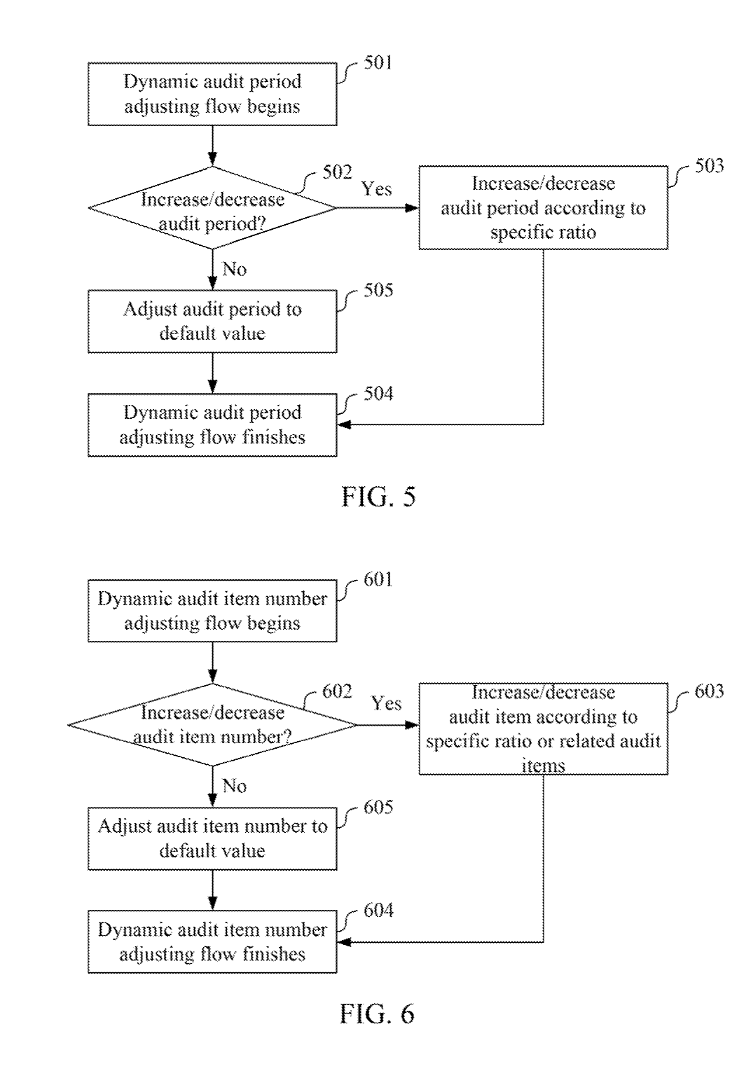

FIG. 5 is a detailed flow chart of step 405 of FIG. 4 for dynamically adjusting the audit period in an embodiment of the present invention.

In step 501, the dynamic audit period adjusting flow begins.

In step 502, whether the audit period is increased or decreased according to the normalized risk evaluation value and/or the risk evaluation value is determined

If the flow depicted in FIG. 5 is the continuation of step 404 it is determined that the audit period is adjusted according to the normalized risk evaluation value and/or the risk evaluation value. The audit period is thus increased or decreased according to a specific ratio in step 503. The flow then continues to step 504 to finish the dynamic audit period adjusting flow.

If the flow depicted in FIG. 5 is the continuation of step 407, it is determined that the audit period is not adjusted according to the normalized risk evaluation value and/or the risk evaluation value. The audit period is adjusted to a default value in step 505. The flow then continues to step 504 to finish the dynamic audit period adjusting flow.

FIG. 6 is a detailed flow chart of step 405 of FIG. 4 for dynamically adjusting the number of the audit items in an embodiment of the present invention.

In step 601, the dynamic audit item number adjusting flow begins.

In step 602, whether the number of the auditing items is increased or decreased according to the normalized risk evaluation value and/or the risk evaluation value is determined.

If the flow depicted in FIG. 6 is the continuation of step 404, it is determined that the number of the auditing items is adjusted according to the normalized risk evaluation value and/or the risk evaluation value. The number of the auditing items is thus increased or decreased according to a specific ratio in or related audit items step 603. The flow then continues to step 604 to finish the dynamic audit item number adjusting flow.

If the flow depicted in FIG. 6 is the continuation of step 407, it is determined that the number of the auditing items is not adjusted according to the normalized risk evaluation value and/or the risk evaluation value. The number of the auditing items is adjusted to a default value in step 605. The flow then continues to step 604 to finish the dynamic audit item number adjusting flow.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

1. An information security audit system, comprising:
a group differentiation module to compute a normalized weighting of each of a plurality of members of an organization according to a level and at least one feature of each of the members;
a risk evaluation module to compute a plurality of risk evaluation values corresponding to a plurality of audit items of the members and to further compute a normalized risk evaluation value of each of the members according to the risk evaluation values and the normalized weighting; and
a dynamic audit module to determine a relation between the normalized risk evaluation value and a plurality of threshold value intervals and/or between the risk evaluation values and the plurality of threshold value intervals to dynamically adjust an audit period and/or a number of the audit items according to the relation.

2. The information security audit system of claim 1, wherein when the normalized risk evaluation value and/or the risk evaluation values varies from a first threshold value interval to a second threshold value interval, wherein any first values in the first threshold value interval is lower than any second values in the second threshold value interval, the dynamic audit module decreases the audit period and/or increases the number of the audit items.

3. The information security audit system of claim 1, wherein when the normalized risk evaluation value and/or the risk evaluation values varies from a first threshold value interval to a second threshold value interval, wherein any first values in the first threshold value interval is larger than any second values in the second threshold value interval, the dynamic audit module increases the audit period and/or decreases the number of the audit items.

4. The information security audit system of claim 1, wherein the dynamic audit module adjusts the audit period and/or the number of the audit items according to a specific ratio or an audit item correlation.

5. The information security audit system of claim 1, wherein the dynamic audit module further adjusts a frequency of a warning message delivering process and/or an event-handling process according to the relation.

6. The information security audit system of claim 1, wherein the feature comprises a member attribute, a member asset, member performance or a combination of the above.

7. The information security audit system of claim 1, further comprising a correlation database, wherein the group categorizing module further stores the level, the feature and the normalized weighting of each of the members in the correlation database.

8. The information security audit system of claim 1, wherein the risk evaluation module performs computation from the normalized risk evaluation value of a lowest-level member to the normalized risk evaluation value of a highest-level member in sequence.

9. The information security audit system of claim 1, wherein the members comprises at least one staff and/or at least one system resource.

10. An information security audit method used in an information security audit system, wherein the information security audit method comprises:
computing a normalized weighting of each of a plurality of members of an organization according to a level and at least one feature of each of the members;
computing a plurality of risk evaluation values corresponding to a plurality of audit items of the members and further computing a normalized risk evaluation value of each of the members according to the risk evaluation values and the normalized weighting; and
determining a relation between the normalized risk evaluation value and a plurality of threshold value intervals and/or between the risk evaluation values and the plurality of threshold value intervals to dynamically adjust an audit period and/or a number of the audit items according to the relation.

11. The information security audit method of claim 10, wherein the step of dynamically adjusting the audit period and/or the number of the audit items further comprises decreasing the audit period and/or increasing the number of the audit items when the normalized risk evaluation value and/or the risk evaluation values varies from a first threshold value interval to a second threshold value interval, wherein any first values in the first threshold value interval is lower than any second values in the second threshold value interval.

12. The information security audit method of claim 10, wherein the step of dynamically adjusting the audit period and/or the number of the audit items further comprises increasing the audit period and/or decreasing the number of the audit items when the normalized risk evaluation value and/or the risk evaluation values varies from a first threshold value interval to a second threshold value interval, wherein any first values in the first threshold value interval is larger than any second values in the second threshold value interval.

13. The information security audit method of claim 10, further comprising adjusting the audit period and/or the number of the audit items according to a specific ratio or an audit item correlation.

14. The information security audit method of claim 10, further comprising adjusting a frequency of a warning message delivering process and/or an event-handling process according to the relation.

15. The information security audit method of claim 10, wherein the feature comprises a member attribute, a member asset, a member performance or a combination of the above.

16. The information security audit method of claim 10, further comprising storing the level, the feature and the normalized weighting of each of the members in a correlation database.

17. The information security audit method of claim 10, wherein the step of computing the normalized weighting further comprises computing the normalized weighting from the normalized weighting of a lowest-level member to the normalized weighting of a highest-level member in sequence.

18. The information security audit method of claim 10, wherein the members comprise at least one staff and/or at least one system resource.

19. A non-transitory computer readable storage medium to store a computer program to execute an information security audit method used in an information security audit system, wherein the information security audit method comprises:
computing a normalized weighting of each of a plurality of members of an organization according to a level and at least one feature of each of the members;
computing a plurality of risk evaluation values corresponding to a plurality of audit items of the members and further computing a normalized risk evaluation value of each of the members according to the risk evaluation values and the normalized weighting; and
determining a relation between the normalized risk evaluation value and a plurality of threshold value intervals and/or between the risk evaluation values and the plurality of threshold value intervals to dynamically adjust an audit period and/or a number of the audit items according to the relation.

20. The non-transitory computer readable storage medium of claim 19, wherein the step of dynamically adjusting the audit period and/or the number of the audit items further comprises decreasing the audit period and/or increasing the number of the audit items when the normalized risk evaluation value and/or the risk evaluation values varies from a first threshold value interval to a second threshold value interval, wherein any first values in the first threshold value interval is lower than any second values in the second threshold value interval, the dynamic audit module.

21. The non-transitory computer readable storage medium of claim 19, wherein the step of dynamically adjusting the audit period and/or the number of the audit items further comprises increasing the audit period and/or decreasing the number of the audit items when the normalized risk evaluation value and/or the risk evaluation values varies from a first threshold value interval to a second threshold value interval, wherein any first values in the first threshold value interval is larger than any second values in the second threshold value interval.

22. The non-transitory computer readable storage medium of claim 19, wherein the information security audit method further comprises adjusting the audit period and/or the number of the audit items according to a specific ratio or an audit item correlation.

23. The non-transitory computer readable storage medium of claim 19, wherein the information security audit method further comprises adjusting a frequency of a warning message delivering process and/or an event-handling process according to the relation.

24. The non-transitory computer readable storage medium of claim 19, wherein the feature comprises a member attribute, a member asset, a member performance or a combination of the above.

25. The non-transitory computer readable storage medium of claim 19, wherein the information security audit method further comprises storing the level, the feature and the normalized weighting of each of the members in a correlation database.

26. The non-transitory computer readable storage medium of claim 19, wherein the step of computing the normalized weighting further comprises computing the normalized weighting from the normalized weighting of a lowest-level member to the normalized weighting of a highest-level member in sequence

27. The non-transitory computer readable storage medium of claim 19, wherein the members comprise at least one staff and/or at least one system resource.
